(19) United States
(12) Patent Application Publication
(10) Pub. No.: US 2014/0040964 A1
(43) Pub. Date: Feb. 6, 2014

(54) Device Memory Allocation for Video Reproduction

(71) Applicant: Michelle Hinners, San Rafael, CA (US)

(72) Inventor: Michelle Hinners, San Rafael, CA (US)

(73) Assignee: Adobe System Incorporated, San Jose, CA (US)

(21) Appl. No.: 12/015,236

(22) Filed: Jan. 16, 2008

(51) Int. Cl. H04N 7/173

(52) U.S. Cl. 725/87

(57) ABSTRACT

A computer-implemented method includes determining a transfer rate of video content as the video content is received by a handheld electronic device. The method also includes allocating a portion of a memory of the handheld device for storing the video content for presentation preparation. The size of the memory portion is based upon the transfer rate of the video content and the difference between the time to transfer the video content and the time to present the video content.

### BACKGROUND

The present disclosure relates to allocating and managing memory of an electronic device for processing video content for reproduction.

Over the past decades television technology has served as one of the primary vehicles for delivering news, sports, entertainment and other types of video and audio content to the general public. With the emergence of the Internet and the person computer, the public is provided the ability to be presented video and audio without being constrained by program scheduling of television stations and networks. To provide such “on-demand” viewing, a person may request that video (e.g., a movie) be delivered from a content provider to their person computer at any time. By incorporating a hardwire connection (e.g., a cable modem, a digital subscriber line (DSL), etc.) with the Internet, the video may be received and stored into relatively large memory, which is typical included in most personal computers, in a short period of time. As such, the stored video may be processed for viewing well in advance of being presented.

### SUMMARY

The specification describes technologies relating to managing memory of electronic devices such as handheld electronic devices.

In general, one aspect of the subject matter described in this specification can be embodied in a computer-implemented method that includes determining a transfer rate of video content as the video content is received by a handheld electronic device. The method also includes allocating a portion of a memory of the handheld device for storing the video content for presentation preparation. The size of the memory portion is based upon the transfer rate of the video content and the difference between the time to transfer the video content and the time to present the video content. Other implementations of this aspect include corresponding systems, apparatus, and computer program products.

These and other implementations can optionally include one or more of the following features. The method may further include allowing the video content in the memory portion to be overwritten upon providing the video content for presentation. The method may also includes if the allocated memory portion size is unavailable, the video content may be stored in an available portion of the memory of the handheld device. The size of the available portion of memory may be less than the size of the allocated portion of memory. The method may include allowing the video content in the available portion to be overwritten upon providing the video content for presentation. The transfer rate determination may be repeated and the size of the allocated memory portion may be adjusted based upon the repeated transfer rate determination. The transfer rate determination may be performed by a virtual machine. The video content may be stored in the allocated memory portion absent storing the video content in another portion of the memory of the handheld electronic device. The video content may includes other types of content such as audio content. The size of the allocated memory portion may be based upon the transfer rate of the video content multiplied to the difference between the time to transfer the video content and the time to present the video content. The transfer rate determination may performed by a virtual machine that uses a scripting language.

In general, another aspect of the subject matter described in this specification can be embodied in a handheld electronic device that includes a memory for storing data and a memory manager for determining a transfer rate of video content as the video content is received by the handheld electronic device. The memory manager is also configured to allocate a portion of the memory of the handheld device for storing the video content for presentation preparation. The size of the memory portion is based upon the transfer rate of the video content and the difference between the time to transfer the video content and the time to present the video content. The handheld electronic device also includes a display for presenting the video content.

These and other implementations can optionally include one or more of the following features. The memory manager may be configured to allow the video content in the memory portion to be overwritten upon the video content being provided for presentation. If the allocated memory portion size is unavailable, the memory manager may be configured to initiate storing of the video content in an available portion of the memory of the handheld device. The size of the available portion of memory may be less than the size of the allocated portion of memory. The memory manager may be configured to allow the video content in the available portion to be overwritten upon the video content being provided for presentation. The memory manager may be configured to repeat the transfer rate determination and adjust the size of the allocated memory portion based upon the repeated transfer rate determination. The memory manager may be performed by a virtual machine. The video content may be stored in the allocated memory portion absent storing the video content in another portion of the memory of the handheld electronic device. The video content may include other types of content such as audio content. The size of the allocated memory portion may be based upon the transfer rate of the video content multiplied to the difference between the time to transfer the video content and the time to present the video content. The transfer rate determination may be performed by a virtual machine that uses a scripting language.

In general, another aspect of the subject matter described in this specification can be embodied in a computer program product, encoded on a computer-readable medium, operable to cause data processing apparatus to perform operations that include determining a transfer rate of video content as the video content is received by a handheld electronic device. Operations also include allocating a portion of a memory of the handheld device for storing the video content for presentation preparation. The size of the memory portion is based upon the transfer rate of the video content and the difference between the time to transfer the video content and the time to present the video content.

These and other implementations can optionally include one or more of the following features. Operations may include allowing the video content in the memory portion to be overwritten upon providing the video content for presentation. Operations may also include if the allocated memory portion size is unavailable, storing the video content in an available portion of the memory of the handheld device. The size of the available portion of memory may be less than the size of the allocated portion of memory. Operations may also include allowing the video content in the available portion to be overwritten upon providing the video content for presentation. Operations may also include repeating the transfer rate determination and adjusting the size of the allocated memory portion based upon the repeated transfer rate determination. The transfer rate determination may be performed by a virtual machine. The video content may be stored in the allocated memory portion absent storing the video content in another portion of the memory of the handheld electronic device. The video content may include other types of content such as audio content. The size of the allocated memory portion may be based upon the transfer rate of the video content multiplied to the difference between the time to transfer the video content and the time to present the video content. The transfer rate determination may be performed by a virtual machine that uses a scripting language.

Particular implementations of the subject matter described in this specification can be implemented to realize one or more of the following advantages. By determining an appropriate memory allocation based upon transmission rate, video content may be stored and presented on electronic devices that include comparatively small amounts of memory.

The details of one or more implementations of the invention are set forth in the accompanying drawings and the description below. Other features, aspects, and advantages of the invention will become apparent from the description, the drawings, and the claims.

### BRIEF DESCRIPTION OF THE DRAWINGS

FIG. 1 illustrates an exemplary environment for providing video content to electronic devices.

FIG. 2 illustrates an exemplary electronic device receiving video content for presentation.

FIG. 3 illustrates an exemplary virtual machine.

FIGS. 4 and 5 are flowcharts that represent exemplary operations of a memory manager.

FIG. 6 is a block diagram of exemplary electronic devices.

Like reference numbers and designations in the various drawings indicate like elements.

### DETAILED DESCRIPTION

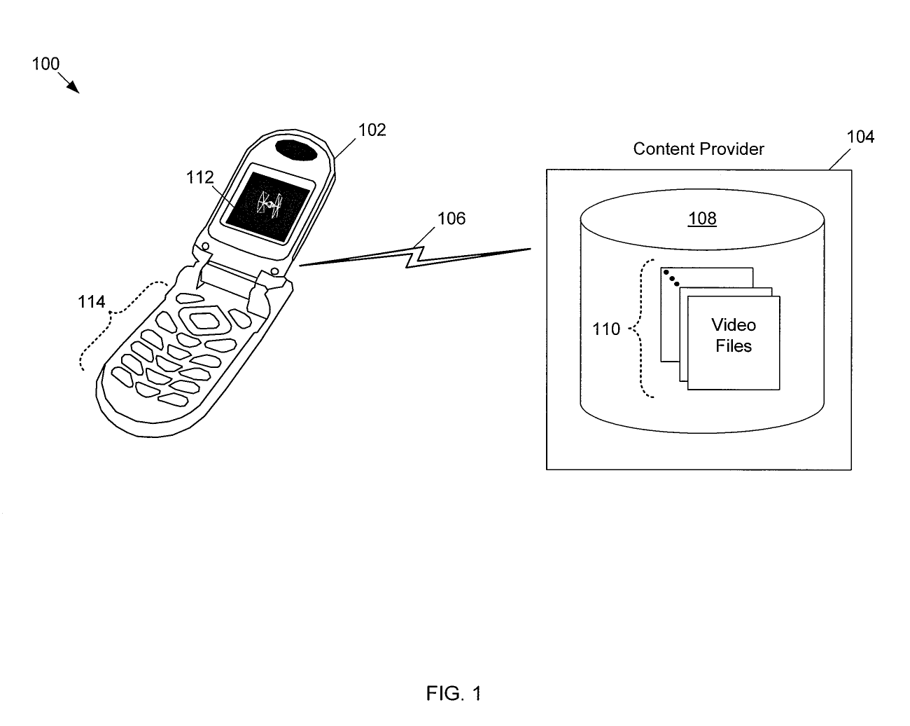

Referring to FIG. 1, an exemplary system 100 is illustrated for providing content to one or more electronic devices for processing and presentation. In this implementation, video and audio content (referred to as video content throughout this disclosure) is provided to a electronic device 102 in an “on-demand” manner such that a user may select a particular piece of video content (e.g., a movie, a television show, a televised sporting event, etc.) for viewing at any time that is stored at a content provider 104. A wireless connection 106 is illustrated as being used to directly pass the video content from the content provider 104 to the electronic device 102, however, additional communication systems and components and may be used to transfer the content. For example one or more local and/or global networks (e.g., local area networks (LANs), the Internet, etc.) may be implemented to assist in transferring the content. In this implementation, a single storage device 108 is implemented to store a group of video files 110 that contain the video content that may be user-selected for delivery. However, in some implementations, multiple types of similar or different storage devices (e.g., hard drives, CD-ROMs, a redundant array of independent disks (RAID), etc.) may be used by the content provider 104 to store video content. Multiple content providers may also be included in the system 100 and one or more networking techniques and methodologies may be used to connect the content providers and allow access to the stored video content by electronic devices. In some implementations, the electronic device 102 is a handheld electronic device such as a mobile phone (e.g., a cellular telephone), smart phone, personal digital assistant (PDA), Blackberry device, electronic gaming device, media player, or combinations of the like or other types of similar devices. The electronic device 102 includes a display 112, which can be touch sensitive, and is integrated into the device 102 (or may be separate from the device). The electronic device 102 also includes a keypad 114, which may be used in conjunction with the display 112 to select the video content provided by the content provider 104. For example, a menu of available video content may be presented on the display 112 and upon making one or more selections with the keyboard 114, a message may be sent from the electronic device 102 (via the wireless connection 106) to the content provider 104 to initiate delivery of the selected content.

Comparatively, a desktop computer system or a laptop computer system typically has vast quantities of memory and processing power compared to a handheld electronic device such as the device 102. So, for example, if alerted to the total size of an incoming video file being delivered by a content provider, a desktop or laptop computer system may simply allocate enough memory to store the entire file. After transfer of the video content has started from the content provider, the initially received video content is stored in the allocated memory and subsequently received video content is appended in a continuous fashion to the previously stored video content. Furthermore, if hardwire network connections are implemented for connecting the desktop or laptop computer system to the content provider, faster data transfer rates may be achieved compared to the wireless connection 106 used by the electronic device 102. Based upon these vast storage capabilities and achievable data rates, desktop and laptop computer systems typically receive video content far in advance of the time at which the content is processed for presentation.

In contrast, comparably smaller and portable handheld electronic devices such as the device 102 typically have considerably less memory space and processing power. Furthermore, data transfer rates of wireless connections such as the connection 106 are considerably lower than hardwire connections. As such, handheld electronic devices are generally unable to entirely store all of the video content of a selected video program. Furthermore, with lower data transfer rates, handheld electronic devices may be unable to receive, store and process video content in a timely manner while still providing a viewer with a relatively seamless viewing experience.

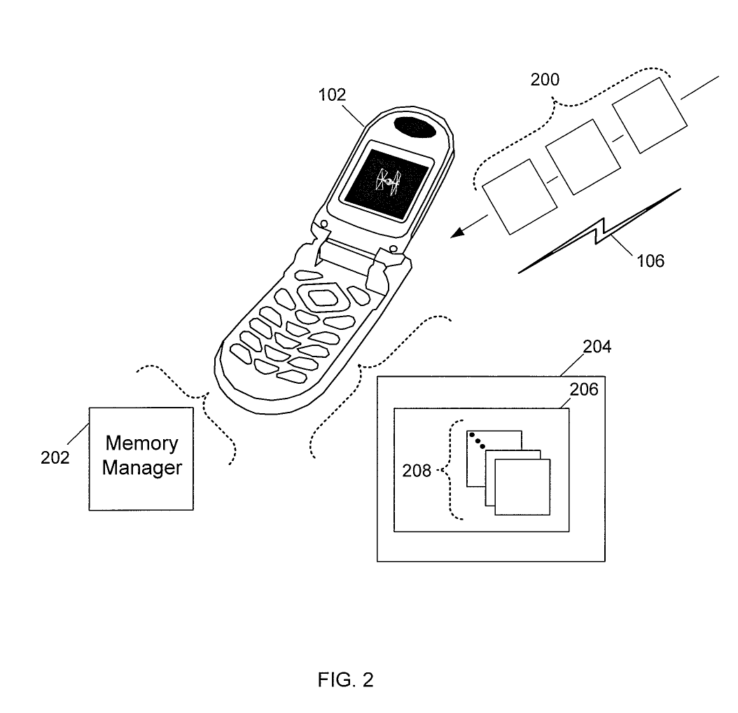

Referring to FIG. 2, to provide such a viewing experience with the limited storage and processing capabilities of a handheld electronic device, an appropriate amount of device memory is allocated to buffer and process a portion of incoming video content. As the processed video content is passed for presenting on the device, the originally stored video content is allowed to be overwritten with newly arriving video content. Thus, by selecting a proper memory allocation, the video content may be stored, processed for presentation and overwritten in a repeated manner without significantly taxing the storage and processing capabilities of the device. For example, the electronic device 102 is illustrated as receiving a stream of data packets 200 (from the content provider 104) that contains a portion of a video file associated with a user selection (e.g., a movie). As the data packets 200 are received, the amount of memory needed to provide an appropriate playback of the video content is determined. Factors such as the rate at which the video content (contained in the stream of data packets 200) is transferred from the content provider 103 and the device 102 along with the rate at which to present the video content are used to calculate the size of memory to be allocated for the video content. By identifying the needed memory allocation, a corresponding amount of video content may be stored in the memory such that the video may be presented at an appropriate playback rate while additional video content is received from the stream 200 and stored.

In this particular arrangement, the electronic device 102 includes a memory manager 202 that monitors the transfer rate of the video content and determines the memory allocation needed to buffer the video content for proper playback. Upon determining the appropriate size, the memory manager 202 allocates a portion of a device memory 204 for storing the video content. In this illustration the device memory 204 may be a random access memory (RAM) or other type of volatile memory (e.g., dynamic RAM (DRAM), static RAM (SRAM), etc.). Storage devices such as hard drives may be implemented, individually or in combination with the device memory 204 for storing the content, however, volatile memory is typically used for its relatively fast accessibility. In this illustration, an allocated memory portion 206 represents the portion of the device memory 204 that the memory manager 202 has allocated for storing received video content.

To reduce memory consumption and processing resources of the electronic device 102, a minimal number of instances of the video content is stored in the device. For example, by storing a single instance of the video content (e.g., contained in the data packet stream 200), the content remains in one location of the device memory 204 until processed for presentation. As such, processing resources are conserved since video content is not copied one or more times, which may require additional processing time and memory space to store the multiple instances of the content. Furthermore, by conserving the amount of memory used, memory fragmentation may be reduced.

In this implementation, to determine the size of the allocated memory 206 for storing video content 208 from the stream 200, the memory manager 202 monitors the transfer rate of the video content received by the electronic device 102 (e.g., from the content provider 104) and uses the rate to calculate the needed memory allocation. As an illustration, suppose the user of the electronic device 102 requests that the content provider 104 provide a one minute video, which has been encoded at 400 kilo-bits/sec. (kbps). Thereby, the total amount of video content to be provided is:

400 kbps*60 seconds=24,000 kilo-bits(3 Mega bytes). (1)

For this example, the wireless connection 106 provides data transfer rate of approximately 300 kilo-bits/sec. As such, the time needed to transfer the video content from the service provider 104 to the electronic device 102 is:

24,000 kilo-bits/300 kps=80 seconds. (2)

In order to play back the video content in an substantially continuous manner as the video content is transferred to the electronic device 102, video content is buffered in the allocated memory 208 of the device memory 204 prior to processing and presentation (e.g., on the device screen 112). To provide a proper buffer size, the size of the allocated memory 208 is established as being proportional to the difference between time to transfer the content and the time length of the entire video content. Thus, for this example, twenty seconds (i.e., 80 seconds (content transfer time) minus 60 seconds (one minute of video content) worth of video content needs to be buffered. For the encoding rate of 300 kbps, the needed size of the allocated memory 206 is:

20 seconds*300 kps=6000 kilo-bits=750 kilo-bytes. (3)

Thus, by sizing the allocated memory 206 to be a relatively small 750 kilo-bytes (i.e., 25% of the original 3 Mega-bytes of video content), the one minute of video may be presented by the electronic device 102 absent significant pauses in the playback. Once the amount of 750 kilo-bytes of video content has been stored, the content may be processed for playback as additional video content is received by the electronic device 102. Since the content stored in the allocated memory 206 is processed at a faster rate (e.g., at least 400 kps) compared to rate that the video content is received (e.g., 300 kps) by the electronic device 102, and by allowing the video content in the allocated memory 206 to be overwritten with newly arriving video content, the allocated memory 206 does not need to be expanded as the video is played back and additional video content is received. Furthermore, by allowing overwriting of the contents stored in the allocated memory 206, the need for executing memory monitoring and management routines may be reduced.

In some situations, the memory 204 of the electronic device 102 may not have available memory to include the allocated memory 206. Returning to the example above, the memory 204 may not have 750 kilo-bytes of memory available to allocate as a video content buffer. In one implementation, for such a situation, the memory manager 202 may determine the maximum amount of available device memory and allocate that portion of memory for storing video content. However, by allocating an amount of memory that is less than the calculated amount (e.g., 750 kilo-bytes), play back of some of the video content may be delayed.

Along with determining and setting the size of the allocated memory 206, the memory manager 202 may dynamically adjust the size of the allocated memory. For example, the memory manager 202 may monitor for changes in the data transfer rate of the video content being provided to the electronic device 102 and adjust the memory size for account for the detected rate variations. For example, as the data transfer rate increases, the memory manager 202 may decrease the size of the allocated memory 206, and for data rate decreases, the allocated memory size may be allowed to increase.

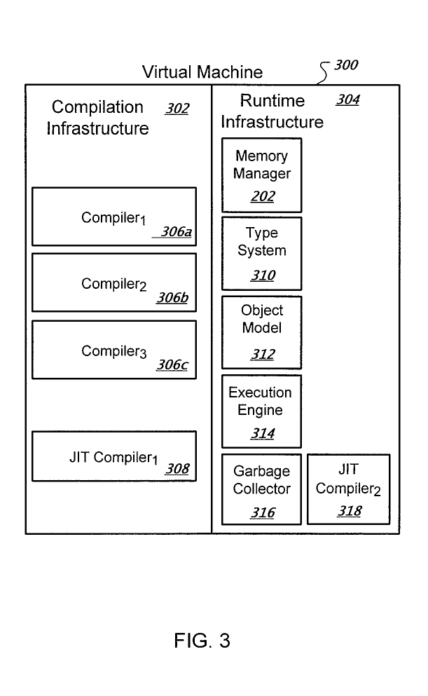

Referring to FIG. 3, the memory manager 202 may be executed in the electronic device 102 using one or more methodologies and techniques. For example, the memory manager 202 may be executed by a virtual machine 300, such as the Adobe® Flash® Player available from Adobe Systems Incorporated (i.e., a virtual machine capable of using embedded scripting language such as ActionScript™), a Java Virtual Machine, or some other virtual machine. In this arrangement, the virtual machine 300 is executed on the electronic device 102 and allows for programs to be executed that can create a rich user interface that allows access to device data and device services. The virtual machine 300 may implement one or more techniques and methodologies for accessing information (e.g., memory management) and services of the device 102. For example, a selection of API's may be used by the virtual machine 300 for accessing data and services of the device 102. Along with providing data and service accessibility, the virtual machine 300 coordinates the loading and execution of programs on the device 102 such as the memory manager 202.

In this particular arrangement, the virtual machine 300 includes a compilation infrastructure 302 and a runtime infrastructure 304. The compilation infrastructure 302 includes one or more compilers (e.g., compilers 306a-c) and a “Just In Time” (JIT) compiler 308 that compiles instructions that need to be interpreted (e.g., Java bytecode) into instructions that can be sent directly to a processor.

In this arrangement, the runtime infrastructure 304, which may be implemented as single-threaded or multi-threaded, includes the memory manager 202 that manages memory for video content storage along with other memory allocation and de-allocation (e.g., in heap memory and other data areas). The runtime infrastructure 304 also includes a type system 310 that tracks object types and object type hierarchies created and used by the device 102. The type system 310 can also store details of object structures and interfaces between objects in an object model 312. The runtime infrastructure 304 also includes an execution engine 314 that can load and execute programs in the virtual machine 300. A garbage collector 316 of the runtime infrastructure 220 identifies memory segments, which have not been referenced within a predefined time period, and indicates to executed programs that the memory segments are available. In some arrangements, the runtime infrastructure 300 may also provide additional functionality such as another JIT compiler 318 that is capable of compiling bytecode into machine executable code at runtime.

As mentioned, the virtual machine 300 can be an ActionScript™ virtual machine, a Java virtual machine, or other similar type of virtual machine, which is capable of compiling multiple source languages into the same intermediate language. For example, the compiler 306a may be capable of compiling Java source code into an intermediate bytecode, while the compiler 306b can compile ActionScript into the same intermediate bytecode, and the compiler 306c can compile C++ source code into the same intermediate bytecode. In this arrangement, the JIT compiler 308 can compile (e.g., before runtime) bytecode generated by one or more of the compilers 306a-c into machine executable code. As another example, the JIT compiler 318 can compile bytecode into machine executable code at runtime.

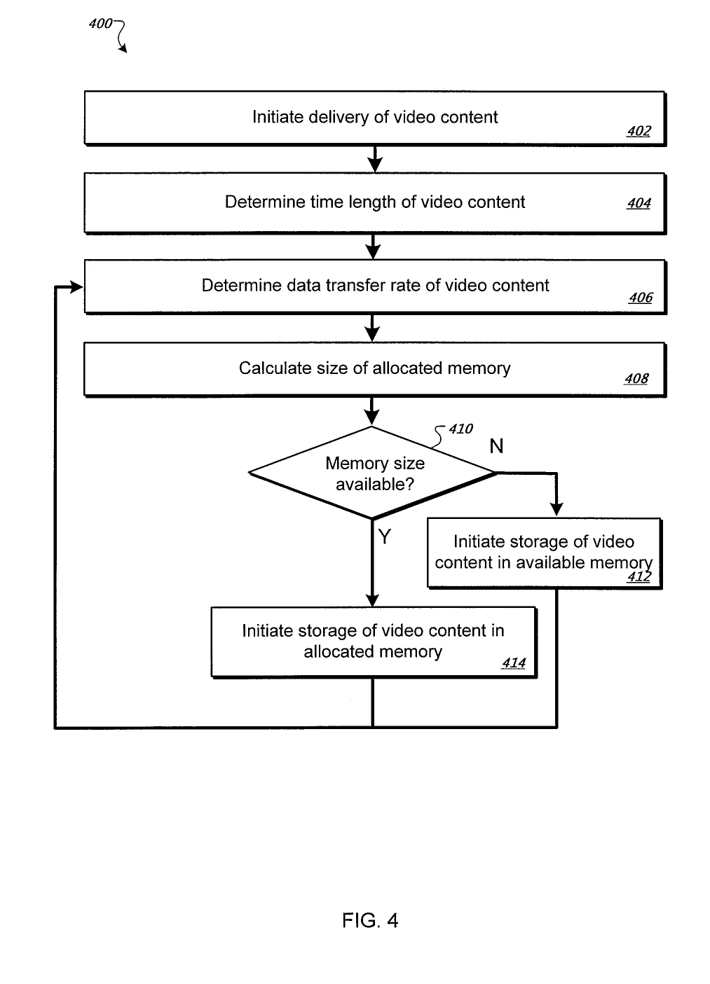

Referring to FIG. 4, a flowchart 400 represents a particular arrangement of operations of the memory manager 202. Typically the operations are executed by a processor present in the electronic device 102 (e.g., a cellular telephone) upon which the memory manger 202 resides, however, the operations may also be executed by multiple processors present in the device. While typically executed by a single electronic device, in some arrangements, operation execution may be distributed among two or more electronic devices.

Operations include initiating 402 delivery of video content. For example, a request may be sent from an electronic device to a content provider that identifies a selected program of video content. Once the video content delivery begins, operations also include determining 404 the time length of the video content. Such information, which represents the time length of the video playback, may be retrieved from the video content (e.g., from the header of a data packet) along with other types of information. Operations also include determining 406 the data transfer rate at which the video content is received at the electronic device. In some implementations, data packets that carry the video content (from a content provider to the device) may be counted as the arrival time of the of the counted packets is measured. From this information, the transfer rate may be calculated by dividing the aggregate amount of video content (contained in the data packets) by the measured delivery time. Other methods and techniques may also be implemented.

Operations also include calculating 408 the memory size to be allocated for buffering the video content. As mentioned, the calculation may account for the difference between the time needed to deliver the video content and the time needed to present the video content. Upon determining the allocated memory size, operations include determining 410 if the allocated memory size is available in the electronic device. If the size is not available, the memory manager 202 initiates 412 storing the video content in the memory that is available. If the allocated size is available, operations of the memory manager 202 include initiate storing 414 of the video content in the allocated memory. Once the content is stored, operations may include returning to determine the data transfer rate of the video content being delivered such that the memory allocation may be adjusted to account for changes in the transfer rate.

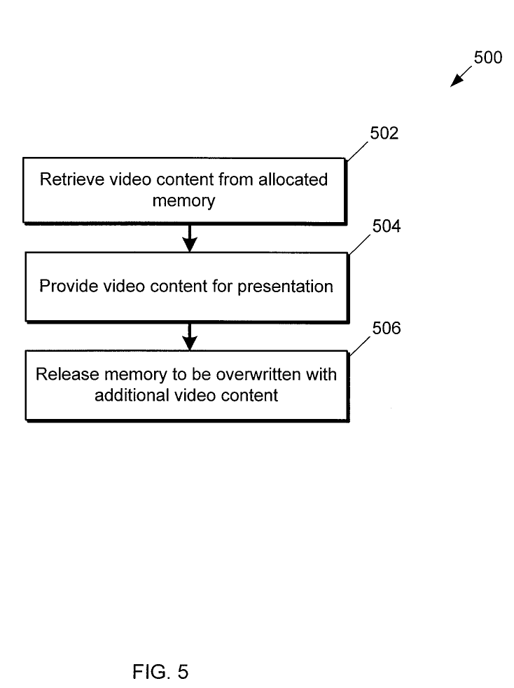

Referring to FIG. 5, a flowchart 500 represents another arrangement of operations of the memory manager 202. Typically the operations are executed by a processor present in the electronic device 102 (e.g., a cellular telephone) upon which the memory manger resides, however, the operations may also be executed by multiple processors present in the device. While typically executed by a single electronic device, in some arrangements, operation execution may be distributed among two or more electronic devices.

Operations include retrieving 502 video content from memory such as memory allocated for video content storage on an electronic device. Operations also include providing 504 the retrieved video content for presentation and releasing 506 the allocated memory that stored the video content for being overwritten with additional video content received by the electronic device.

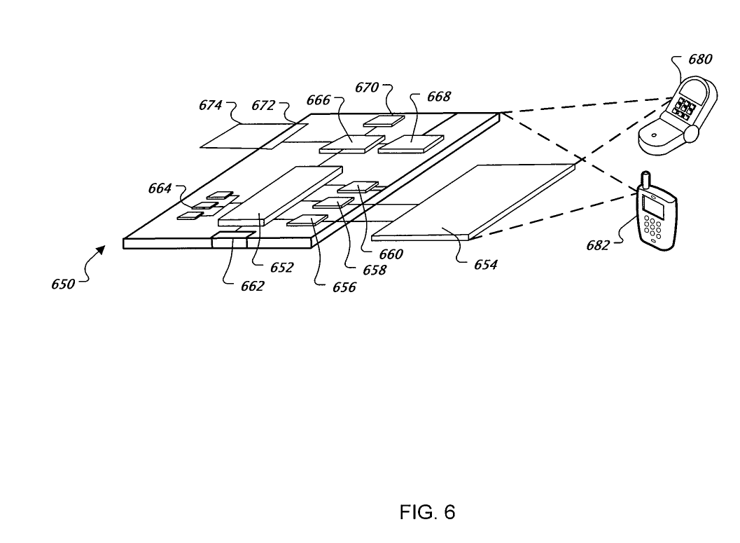

FIG. 6 is a block diagram of computing devices 650 that may be used to implement the systems and methods described in this document, as either a client or as a server or plurality of servers. Computing device 650 is intended to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this document.

Computing device 650 includes a processor 652, memory 664, an input/output device such as a display 654, a communication interface 666, and a transceiver 668, among other components. The device 650 may also be provided with a storage device, such as a microdrive or other device, to provide additional storage. Each of the components 650, 652, 664, 654, 666, and 668, are interconnected using various buses, and several of the components may be mounted on a common motherboard or in other manners as appropriate.

The processor 652 can process instructions for execution within the computing device 650, including instructions stored in the memory 664. The processor may also include separate analog and digital processors. The processor may provide, for example, for coordination of the other components of the device 650, such as control of user interfaces, applications run by device 650, and wireless communication by device 650.

Processor 652 may communicate with a user through control interface 658 and display interface 656 coupled to a display 654. The display 654 may be, for example, a TFT LCD display or an OLED display, or other appropriate display technology. The display interface 656 may comprise appropriate circuitry for driving the display 654 to present graphical and other information to a user. The control interface 658 may receive commands from a user and convert them for submission to the processor 652. In addition, an external interface 662 may provide communication with processor 652, so as to enable near area communication of device 650 with other devices. External interface 662 may provide, for example, for wired communication (e.g., via a docking procedure) or for wireless communication (e.g., via Bluetooth or other such technologies).

The memory 664 stores information within the computing device 650. In one implementation, the memory 664 is a computer-readable medium. In one implementation, the memory 664 is a volatile memory unit or units. In another implementation, the memory 664 is a non-volatile memory unit or units. Expansion memory 674 may also be provided and connected to device 650 through expansion interface 672, which may include, for example, a SIMM card interface. Such expansion memory 674 may provide extra storage space for device 650, or may also store applications or other information for device 650. Specifically, expansion memory 674 may include instructions to carry out or supplement the processes described above, and may include secure information also. Thus, for example, expansion memory 674 may be provided as a security module for device 650, and may be programmed with instructions that permit secure use of device 650. In addition, secure applications may be provided via the SIMM cards, along with additional information, such as placing identifying information on the SIMM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 664, expansion memory 674, memory on processor 652, or a propagated signal.

Device 650 may communicate wirelessly through communication interface 666, which may include digital signal processing circuitry where necessary. Communication interface 666 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 668. In addition, short-range communication may occur, such as using a Bluetooth, WiFi, or other such transceiver (not shown). In addition, GPS receiver module 670 may provide additional wireless data to device 650, which may be used as appropriate by applications running on device 650.

Device 650 may also communicate audibly using audio codec 660, which may receive spoken information from a user and convert it to usable digital information. Audio codex 660 may likewise generate audible sound for a user, such as through a speaker, e.g., in a handset of device 650. Such sound may include sound from voice telephone calls, may include recorded sound (e.g., voice messages, music files, etc.) and may also include sound generated by applications operating on device 650.

The computing device 650 may be implemented in a number of different forms, as shown in the figure. For example, it may be implemented as a cellular telephone 680. It may also be implemented as part of a smartphone 682, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. For example, various forms of the flows shown above may be used, with steps re-ordered, added, or removed. Also, although several applications of the systems and methods have been described, it should be recognized that numerous other applications are contemplated. Accordingly, other embodiments are within the scope of the following claims.

Implementations of the subject matter and the functional operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a computer-readable medium for execution by, or to control the operation of, data processing apparatus. The computer-readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

While this specification contains many specifics, these should not be construed as limitations on the scope of the invention or of what may be claimed, but rather as descriptions of features specific to particular implementations of the invention. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the invention have been described. Other implementations are within the scope of the following claims. For example, the actions recited in the claims can be performed in a different order and still achieve desirable results.

What is claimed is:

1. A computer-implemented method comprising:
determining a transfer rate of video content as the video content is received by a device;
allocating a portion of a memory of the device for storing the video content for presentation preparation, wherein the size of the allocated memory portion is based on the transfer rate of the video content multiplied to the difference between a time length to transfer the video content at the device and a time length of the video content;
increasing a limit of the size of the allocated memory portion when the transfer rate of the video content decreases; and
if the size of the allocated memory portion is unavailable, storing the video content in an available portion of the memory of the device, wherein the size of the available portion of memory is less than the size of the allocated memory portion.

2. The computer-implemented method of claim 1, further comprising:
allowing the video content in the memory portion to be overwritten upon providing the video content for presentation.

3. (canceled)

4. The computer-implemented method of claim 1, further comprising:
allowing the video content in the available portion to be overwritten upon providing the video content for presentation.

5. The computer-implemented method of claim 1, further comprising:
repeating the transfer rate determination; and
adjusting the size of the allocated memory portion based upon the repeated transfer rate determination.

6. The computer-implemented method of claim 1, in which the transfer rate determination is performed by a virtual machine.

7. The computer-implemented method of claim 1, in which the video content is stored in the allocated memory portion absent storing the video content in another portion of the memory of the handheld electronic device.

8. The computer-implemented method of claim 1, in which the video content includes audio content.

9. (canceled)

10. The computer-implemented method of claim 1, in which the transfer rate determination is performed by a virtual machine that uses a scripting language.

11. A handheld electronic device comprising:
a memory for storing data;
a memory manager for determining a transfer rate of video content as the video content is received by the device, the memory manager is also configured to allocate a portion of the memory of the device for storing the video content for presentation preparation, wherein the size of the allocated memory portion is based on the transfer rate of the video content multiplied to the difference between a time length to transfer the video content at the device and a time length of the video content, and the memory manager is also configured to increase a limit of the size of the allocated memory portion when the transfer rate of the video content decreases, and if the size of the allocated memory portion is unavailable, to initiate storing the video content in an available portion of the memory of the device, wherein the size of the available portion of memory is less than the size of the allocated memory portion; and
a display for presenting the video content.

12. The handheld electronic device of claim 11, in which the memory manager is configured to allow the video content in the memory portion to be overwritten upon the video content being provided for presentation.

13. (canceled)

14. The handheld electronic device of claim 11, in which the memory manager is configured to allow the video content in the available portion to be overwritten upon the video content being provided for presentation.

15. The handheld electronic device of claim 11, in which the memory manager is configured to repeat the transfer rate determination and adjust the size of the allocated memory portion based upon the repeated transfer rate determination.

16. The handheld electronic device of claim 11, in which the memory manager is performed by a virtual machine.

17. The handheld electronic device of claim 11, in which the video content is stored in the allocated memory portion absent storing the video content in another portion of the memory of the handheld electronic device.

18. The handheld electronic device of claim 11, in which the video content includes audio content.

19. (canceled)

20. The handheld electronic device of claim 11, in which the transfer rate determination is performed by a virtual machine that uses a scripting language.

21. A computer program product, encoded on a computer-readable storage device, operable to cause data processing apparatus to perform operations comprising:
determining a transfer rate of video content as the video content is received by a device;
allocating a portion of a memory of the device for storing the video content for presentation preparation, wherein the size of the allocated memory portion is based on the transfer rate of the video content multiplied to the difference between a time length to transfer the video content at the device and a time length of the video content;
increasing a limit of the size of the allocated memory portion when the transfer rate of the video content decreases; and
if the size of the allocated memory portion is unavailable, storing the video content in an available portion of the memory of the device, wherein the size of the available portion of memory is less than the size of the allocated memory portion.

22. The computer program product of claim 21, further operable to cause data processing apparatus to perform operations comprising:
allowing the video content in the memory portion to be overwritten upon providing the video content for presentation.

23. (canceled)

24. The computer program product of claim 21, further operable to cause data processing apparatus to perform operations comprising:
allowing the video content in the available portion to be overwritten upon providing the video content for presentation.

25. The computer program product of claim 21, further operable to cause data processing apparatus to perform operations comprising:
repeating the transfer rate determination; and
adjusting the size of the allocated memory portion based upon the repeated transfer rate determination.

26. The computer program product of claim 21, in which the transfer rate determination is performed by a virtual machine.

27. The computer program product of claim 21, in which the video content is stored in the allocated memory portion absent storing the video content in another portion of the memory of the handheld electronic device.

28. The computer program product of claim 21, in which the video content includes audio content.

29. (canceled)

30. The computer program product of claim 21, in which the transfer rate determination is performed by a virtual machine that uses a scripting language.

31. The computer-implemented method of claim 1, further comprising:
decreasing the limit of the size of the allocated memory portion when the transfer rate of the video content increases.

32. The handheld electronic device of claim 11, wherein the memory manager is further configured to decrease the limit of the size of the allocated memory portion when the transfer rate of the video content increases.

33. The computer program product of claim 21, further operable to decrease the limit of the size of the allocated memory portion when the transfer rate of the video content increases.
